(19) United States
(12) Patent Application Publication
(10) Pub. No.: US 2013/0068564 A1
(43) Pub. Date: Mar. 21, 2013

(54) Lube by Number

(71) Applicants: Dean Frederic Stebner, Mayfield Heights, OH (US); John Warren Harley, Peninsula, OH (US)

(72) Inventors: Dean Frederic Stebner, Mayfield Heights, OH (US); John Warren Harley, Peninsula, OH (US)

(21) Appl. No.: 13/623,897

(22) Filed: Sep. 21, 2012

Related U.S. Application Data
(60) Provisional application No. 61/537,075, filed on Sep. 21, 2011.

(51) Int. Cl. F16N 19/00; B65D 71/00

(52) U.S. Cl. 184/109; 206/223

(57) ABSTRACT

An architecture is presented that provides a lubricating kit that discloses an easy to follow system of product application. The lubricating kit comprises a lubricating guide and a purpose built case for housing the lubricants. The lubricating guide provides lubrication instructions and identifies each product and surface where each product is applied. The purpose built case comprises all types of industrial lubricants that technicians or other lubricant users may need. The lubricants comprise product labels that follow the lubrication guide. Specifically, the product containers of the lubricating kit are color coded and numbered to correspond with the colors and numbers on the lubricating guide, thus allowing a user to identify a specific product for a specific surface and purpose. Thus, the lubricating guide identifies a surface in need of lubrication, recommends a specific product for the task, and provides basic application directions and durability estimates.

### CROSS-REFERENCE

This application claims priority from Provisional Patent Application Ser. No. 61/537,075 filed Sep. 21, 2011.

### BACKGROUND

Industrial lubricants have been available for many years. However, most users of industrial lubricants do not utilize a controlled system to evaluate the surface to be lubricated for suitability to a specific type or formulation of lubricant, manage lubricant selection and application, and dispense the lubricants based on their effective life-span and suitability to a particular application or environment. Instead, industrial lubricants are commonly dispensed for maintenance purposes without much planning or forethought to the purpose and durability requirements of a particular surface or environment, and generally not evaluated or replaced until a major issue arises in the equipment. However, understanding of lubricant properties and suitability of different lubricant types and formulations is necessary to perform the regular lubrication that is needed for most equipment to run smoothly and continuously without break-down or other interruption. If lubrication is not purpose selected and a maintenance cycle not established, prior to encountering an issue, then regular maintenance may not be effective in mitigating or avoiding an equipment failure due to deteriorated lubricant. This is a common issue in industrial environments mainly due to users who are not aware of the lubricant types needed for specific surface types, the viable service life of lubricants, and the lack of an established, easy to use system. Therefore, there is a continuing need for an industrial lubrication system that provides users with instructions and ways to identify surfaces to be lubricated.

A quality system that controls the types of lubricants used in specific applications would help users to maintain regular lubrication maintenance on their equipment. It is therefore desirable to provide an industrial lubrication system that provides industrial lubricant products in a protective case and includes an instructional lubrication guide for identifying a specific lubricant for a specific surface and purpose.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a lubricating kit that provides an easy to follow system of product application by identifying the surface where the product is applied. The lubricating kit comprises a color-coded and numbered lubricating guide and a purpose built case for housing the lubricants. The lubricating guide provides lubrication instructions and identifies each product and identifies the surface where each product is applied. The purpose built case comprises all types of industrial lubricants that technicians or other lubricant users may need.

Furthermore in the preferred embodiment of the present invention, the lubricating kit comprises product labels that follow the lubricating guide which provides a user with an easy to follow system. The lubricating guide identifies a surface in need of lubrication, recommends a specific product for the task, and provides basic application directions and durability estimates. Specifically, the product containers of the lubricating kit are color coded and numbered to correspond with the colors and numbers on the lubricating guide, thus allowing a user to identify a specific product for a specific surface and purpose.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a purpose built case for the lubricating kit in accordance with the disclosed architecture.

FIG. 2 illustrates a flow chart of the lubricating guide for using the lubricating kit in accordance with the disclosed architecture.

FIG. 3 illustrates a flow chart of the sample product contents in a standard layout configuration of the lubricating kit in accordance with the disclosed architecture.

FIG. 4 illustrates a method of providing lubrication maintenance on equipment in accordance with the disclosed architecture.

FIG. 5 illustrates further aspects in the method of providing lubrication maintenance on equipment of FIG. 4.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A quality system that controls the types of lubricants used in specific applications would help users to maintain regular lubrication maintenance on their equipment. The industrial lubrication system of the present invention provides industrial lubricant products in a protective case and includes an instructional lubrication guide for identifying a specific lubricant for a specific surface and purpose. Thus, the lubricating kit discloses an easy to follow system of product application. The lubricating kit comprises a lubricating guide and a purpose built case for housing the lubricants. The lubricating guide provides lubrication instructions and identifies each product and surface where each product is applied. The purpose built case comprises all types of industrial lubricants that technicians or other lubricant users may need. The product (lubricant) containers of the lubricating kit are color coded and numbered to correspond with the colors and numbers on the lubricating guide. Thus, the lubricating guide identifies a surface in need of lubrication, recommends a specific product for the task, and provides basic application directions and durability estimates.

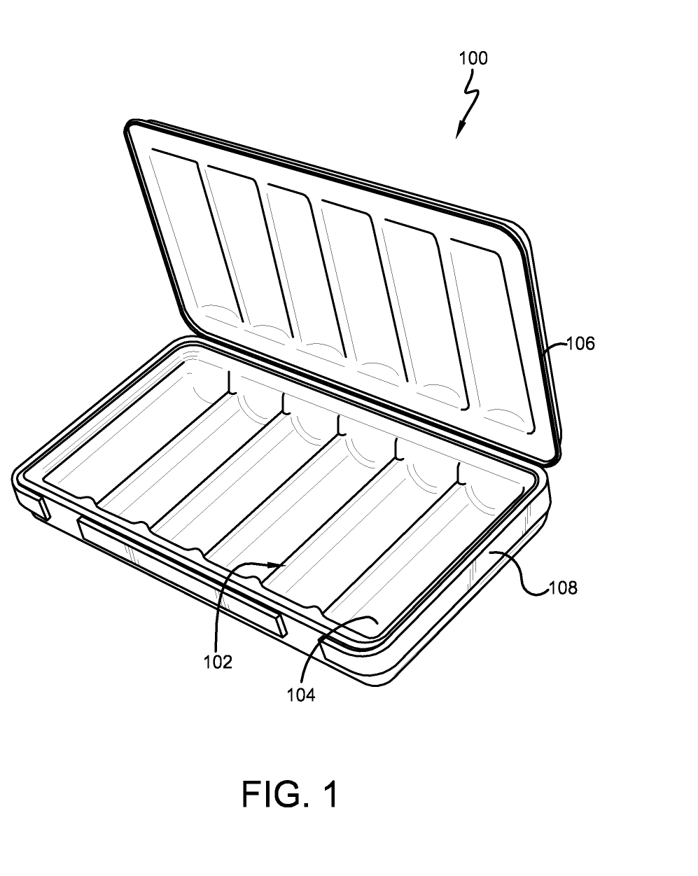

Referring initially to the drawings, FIGS. 1-3 illustrate the sample product contents and standard layout configuration of the lubricating kit. The lubricating kit comprises a purpose built case 100 and a lubricating guide 200. As shown in FIG. 1, the case 100 is a purpose built case but could be any suitable case as is known in the art for housing lubricant containers without affecting the overall concept of the invention. The case 100 can be utilized in a variety of custom and standard sizes. Further, the case is typically made of High Density Polyethylene (HDPE), but could be made of any suitable Petroleum Resistant Plastic without affecting the overall concept of the invention. The inside 102 of the case 100 can be constructed to include recessed areas 104 on the lid 106 and base 108 for retaining lubricant containers of varying sizes and shapes. However, the case 100 need not include such recessed areas and can function with a single uniform opening as well.

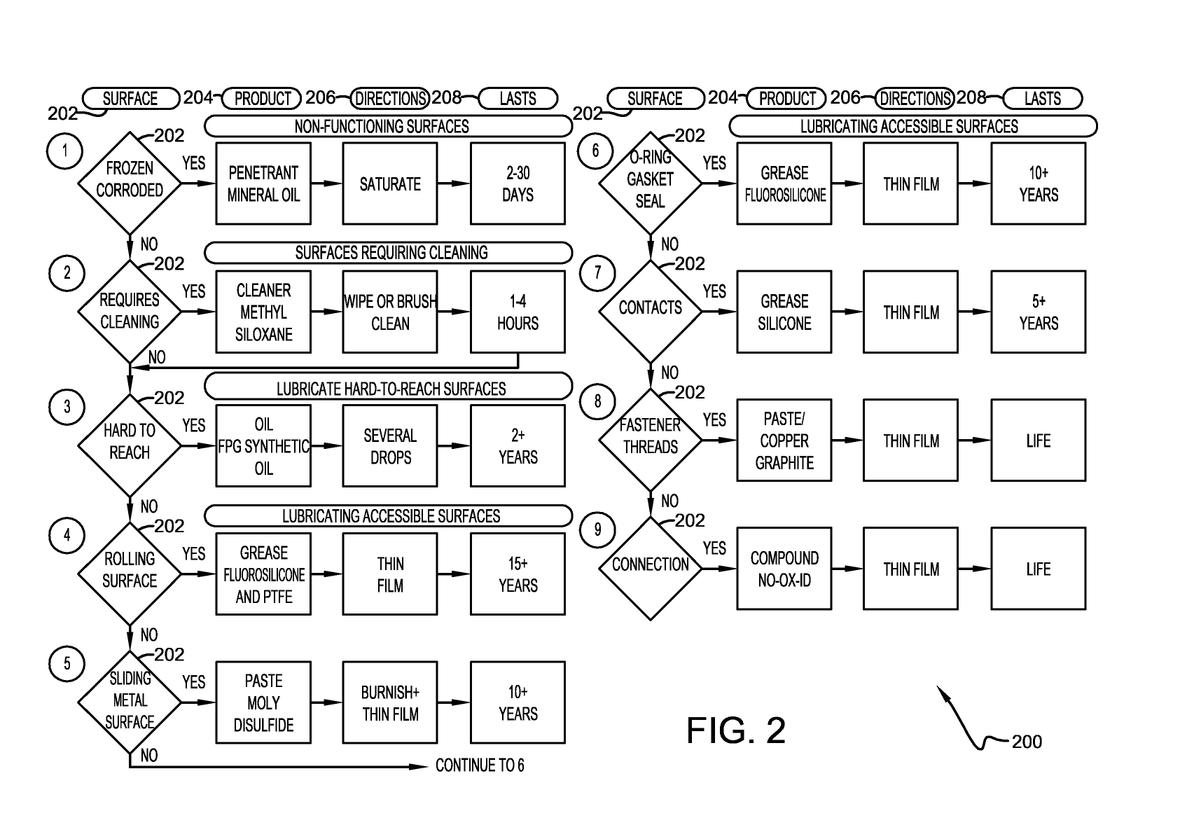

As illustrated in FIG. 2, the lubricating guide 200 is a color-coded and numbered instructional flow chart. The lubricating guide provides lubrication instructions and identifies each product and identifies the surface where each product is applied. Specifically, there are nine different surfaces 202 identified such as non-functioning surfaces, surfaces that require cleaning, hard-to-reach surfaces, lubricating accessible surfaces, etc. Instructions are then given for each surface 202 to identify the product 204 that should be used for lubrication, the directions 206 for using the specific lubricant, and the duration (how long the lubricant will last) 208 of the lubricant. The directions 206 disclose how a user should apply the specific lubricant identified, such as saturating the surface, wiping or brushing the surface clean, applying several drops, or applying a thin film, etc. Then, the duration 208 of the lubricant is disclosed, such as 2-30 days, 1-4 hours, 2+ years, 5+ years, life, etc. Thus, the lubricating guide 200 identifies a surface 202 in need of lubrication, recommends a specific product 204 for the task, and provides basic application directions 206 and durability 208 estimates.

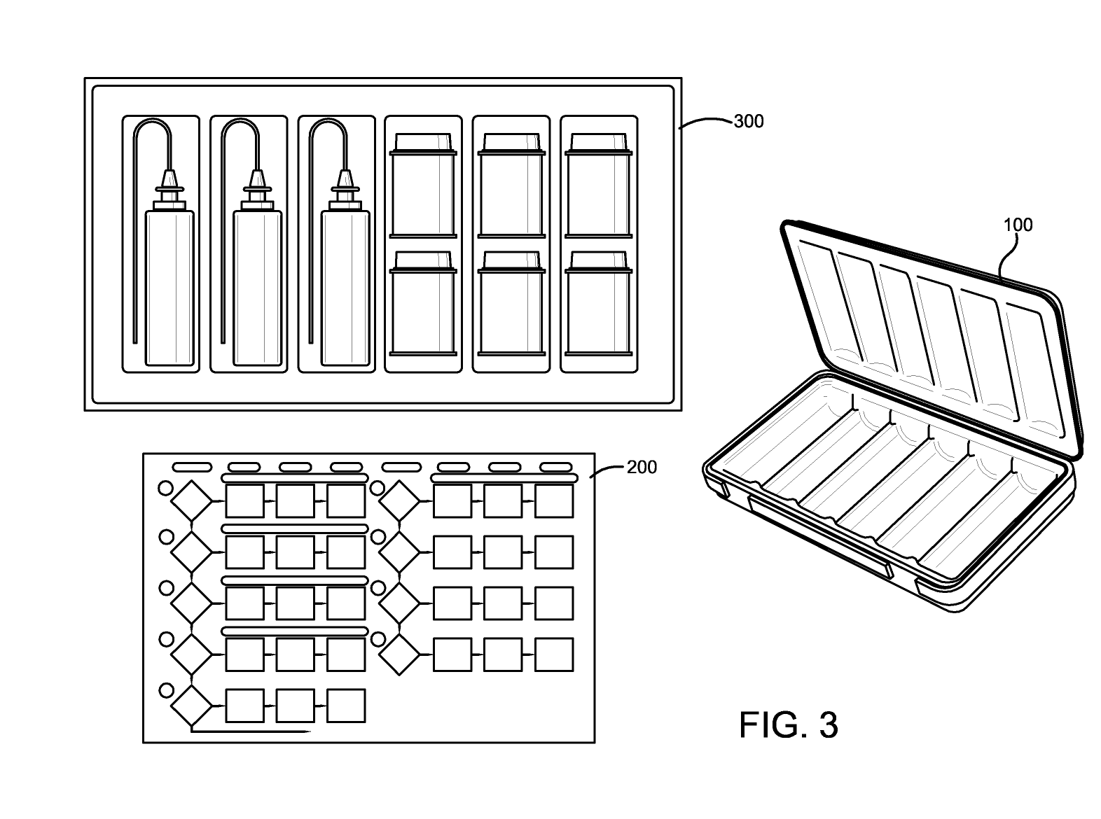

FIG. 3 discloses the lubricating kit comprising sample product contents 300 in a standard layout configuration. Specifically, the lubricating kit comprises an instructional flow chart 200 and a purpose built case 100 for securing the lubricants. The lubricants include all types of industrial lubricants that a technician or other lubricant user may need. The product (lubricant) containers of the lubricating kit are color coded and numbered to correspond with the colors and numbers on the lubricating guide, thus allowing a user to identify a specific product for a specific surface and purpose.

In use, a user of the lubricating kit would first determine the surface(s) that need to be lubricated. Then, the user would utilize the lubrication guide 200 to find the surface(s) that needs to be lubricated on the lubrication guide flow chart 200. A user would start at the first identified surface 202 and follow the numbered flow chart down through the list of nine surfaces 202 to find the surface 202 that matches with the surface they need to lubricate. Once the surface 202 is identified, the user would then follow the flow chart across to identify the product (lubricant) 204 that needs to be used for lubricating the identified surface. The products 204 are color coded and numbered on the flow chart 200 to correspond with the colors and numbers on the product (lubricant) containers 300 disposed in the case 100. Once the specific product 204 has been identified, the corresponding product container 300 is retrieved from the case 100. Then, the user returns to the flowchart to determine the application directions 206 for the lubricant. The user then follows the flow chart across to identify the durability 208 estimates. The user utilizes the application directions 206 and durability 208 estimates to determine how to apply the lubricant to the surface and to identify the duration of the lubricant on the surface. The user follows the directions and lubricates the surface with the lubricant as directed. Thus, the lubricating kit provides an easy to follow system of product application.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

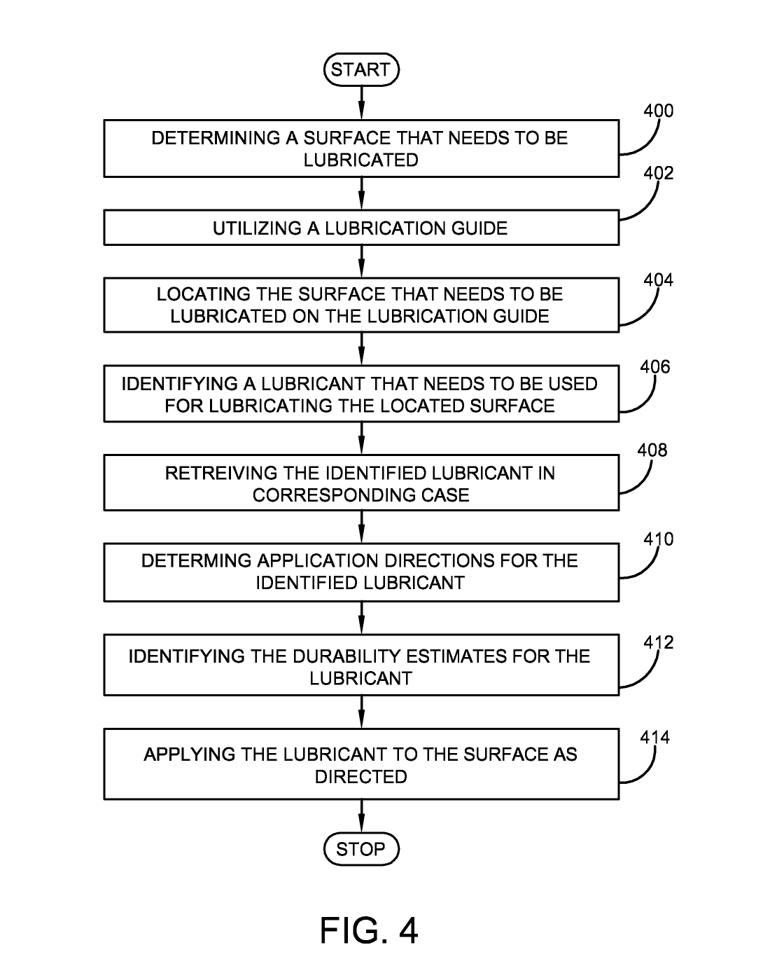

Referring initially to the drawings, FIG. 4 illustrates a method of providing lubrication maintenance on equipment. The method allows for controlling the types of lubricants used in specific applications and helps users maintain regular lubrication maintenance on their equipment. At 400, a surface that needs to be lubricated is determined. A user identifies what lubrication maintenance is needed for the equipment and identifies specific surfaces to lubricate. At 402, the lubrication guide is utilized. At 404, the surface that needs to be lubricated is located on the lubrication guide. Specifically, the surface is located on the lubrication guide via following a numbered flow chart down through a list of surfaces to find the surface that matches.

At 406, the lubricant that needs to be used for lubricating the located surface is identified. The lubricant is identified on the lubrication guide via following the numbered flow chart across from the located surface. At 408, the identified lubricant is then retrieved in the corresponding case. The lubricants are color coded and numbered on the flow chart to correspond with the colors and numbers on the lubricant containers disposed in the case. Once the specific lubricant has been identified, the corresponding lubricant container is retrieved from the case. At 410, the application directions are determined for the identified lubricant. At 412, the durability estimates are identified for the lubricant. And at 414, the lubricant is applied to the surface as directed. The user follows the directions and lubricates the surface with the lubricant as directed.

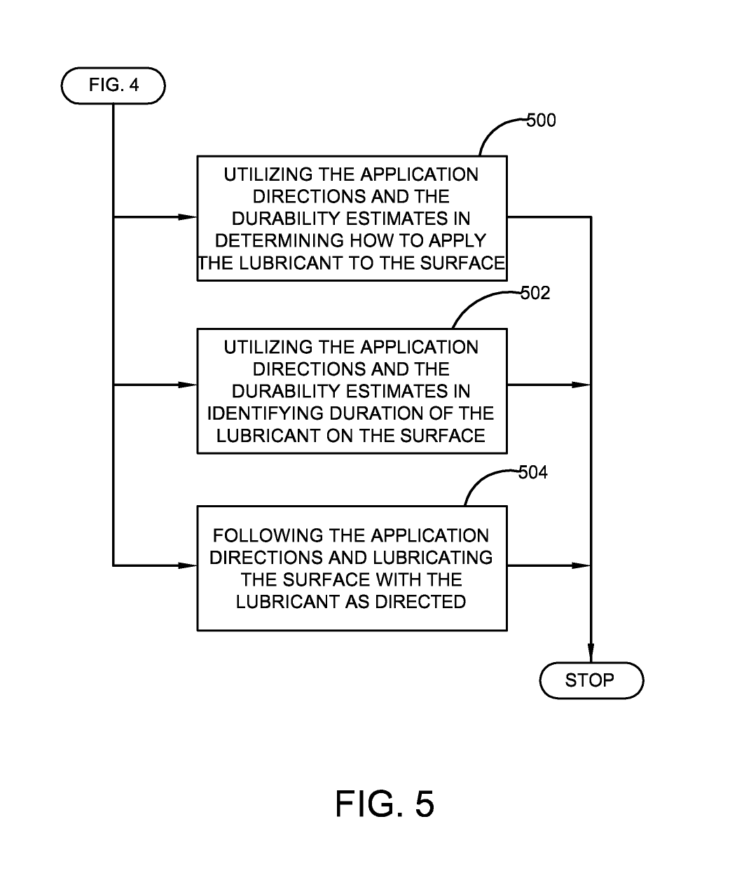

FIG. 5 illustrates further aspects in the method of providing lubrication maintenance on equipment of FIG. 4. At 500, the application directions and the durability estimates are utilized in determining how to apply the lubricant to the surface. At 502, the application directions and the durability estimates are utilized in identifying duration of the lubricant on the surface. Specifically, the user utilizes the application directions and durability estimates to determine how to apply the lubricant to the surface and to identify the duration of the lubricant on the surface. And at 504, the application directions are followed and the surface is lubricated with the lubricant as directed. The user follows the directions and lubricates the surface with the lubricant as directed.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lubricating system comprising:
a lubricating guide;
a plurality of lubricants; and
a case.

2. The lubricating system of claim 1, wherein the lubricating guide is color-coded.

3. The lubricating system of claim 2, wherein the lubricating guide is numbered.

4. The lubricating system of claim 3, wherein the plurality of lubricants comprise product labels that correspond to the lubricating guide.

5. The lubricating system of claim 4, wherein the product labels are color-coded.

6. The lubricating system of claim 5, wherein the product labels are numbered.

7. The lubricating system of claim 1, wherein the case is a purpose built case for housing the plurality of lubricants.

8. A lubricating system that discloses an easy to follow system of product application comprising:
a lubricating guide;
a plurality of lubricants each comprising a product label; and
a case for housing the plurality of lubricants.

9. The lubricating system of claim 8, wherein the product labels correspond to the lubricating guide.

10. The lubricating system of claim 9, wherein the product labels are color-coded.

11. The lubricating system of claim 10, wherein the product labels are numbered.

12. The lubricating system of claim 8, wherein the case is a purpose built case for housing the plurality of lubricants.

13. The lubricating system of claim 8, wherein the lubricating guide is color-coded.

14. The lubricating system of claim 13, wherein the lubricating guide is numbered.

15. A method of providing lubrication maintenance on equipment, comprising:
determining a surface that needs to be lubricated;
utilizing a lubrication guide;
locating the surface that needs to be lubricated on the lubrication guide;
identifying a lubricant that needs to be used for lubricating the located surface;
retrieving the identified lubricant in corresponding case;
determining application directions for the identified lubricant;
identifying durability estimates for the lubricant; and
applying the lubricant to the surface as directed.

16. The method of claim 15, wherein the surface is located on the lubrication guide via following a numbered flow chart down through a list of surfaces to find the surface that matches.

17. The method of claim 16, wherein the lubricant is identified on the lubrication guide via following the numbered flow chart across from the located surface.

18. The method of claim 17, wherein the lubricants comprise product labels that are color-coded and numbered.

19. The method of claim 18, wherein the flow chart is color-coded and numbered to correspond with the color-coding and numbers on the product labels.

20. The method of claim 19, further comprising: utilizing the application directions and the durability estimates in determining how to apply the lubricant to the surface; and utilizing the application directions and the durability estimates in identifying duration of the lubricant on the surface; and following the application directions and lubricating the surface with the lubricant as directed.
